(19) United States
(12) Patent Application Publication
(10) Pub. No.: US 2024/0275084 A1
(43) Pub. Date: Aug. 15, 2024

(54) CONTACT INSERT FOR AN INDUSTRIAL PLUG CONNECTOR

(71) Applicant: HARTING ELECTRIC STIFTUNG & CO. KG, Espelkamp (DE)

(72) Inventors: Christof HERMONI, Rahden (DE); Wilhelm KLIEVER, Minden (DE); André BENEKE, Vechta (DE)

(21) Appl. No.: 18/563,555

(22) PCT Filed: May 13, 2022
(86) PCT No.: PCT/DE2022/100359

§ 371 Date: Nov. 22, 2023

(30) Foreign Application Priority Data
May 26, 2021 (DE) 10 2021 113 557.5

(51) Int. Cl. H01R 9/24; H01R 13/11

(52) U.S. Cl. CPC H01R 9/2466; H01R 9/2483; H01R 9/2491; H01R 13/111

(57) ABSTRACT

A contact insert for an industrial plug connector is provided. The contact insert has a connection side for connecting individual conductors of a multi-wire cable and a contact side for electrically connecting to a mating plug connector or a socket, wherein n connection openings for respective conductors of the multi-wire cable are provided on the connection side, m contact openings for accessing a mating contact element of a mating plug connector or a socket are provided on the contact side, and n and m are natural numbers, m being greater than n. A system for a plug connector housing and a contact insert are also provided.

### BACKGROUND

### Technical Field

The present disclosure relates to a contact insert for an industrial plug connector, and a system of a plug connector housing and a contact insert.

Such contact inserts are needed when the currents of individual conductors of a multi-strand cable must be divided within the plug connector. This is the case in so-called data centers, for example. Here, the so-called neutral conductor of the connected cable must be divided among the individual server units of a data rack within the data rack.

### Prior Description of the Related Art

The document DE 20 2007 017 892 U1 discloses a contact insert for industrial plug connectors having a PE plate.

Wherever it is necessary to bridge individual conductors for specific applications, the conductors have until now been bridged inside the plug connector housing. Sufficient space must be present and a correspondingly sized housing must be selected for this. Bridging inside the housing entails a large hazard potential. If the mechanical connection of the bridged conductors does not hold, current-carrying conductors can reach the plug connector housing.

The German Patent and Trade Mark Office has searched the following prior art in the priority application for the present application: DE 199 45 317 A1, DE 93 07 260 U1, DE 196 51 171 A1, U.S. Pat. No. 6,162,089 A and US 2004/0166737 A1.

### BRIEF SUMMARY

Embodiments of the present disclosure provide a contact insert for industrial plug connectors that is safe, compact and convenient to connect to a cable.

The contact insert described herein is intended for use in an industrial plug connector. Such plug connectors usually have a rectangular cross section and are used in particular in harsh industrial environments. The contact inserts used also generally have a cuboidal basic shape with a rectangular cross section.

The contact inserts may be fixed in the plug connector housing, for example, by a so-called holding frame. Alternatively, the contact inserts may also be fixed directly in the plug connector housing.

The contact insert described herein has a connection side for connecting individual conductors of a multi-strand cable. On the connection side, the conductors of the cable are connected to the contact insert. The contact insert has a contact side for electrical connection to a mating plug connector or a socket. The contact to the mating plug connector or socket is made on the contact side.

The contact insert described herein has n connection openings on the connection side for the individual conductors of the multi-strand cable. On the contact side, the contact insert has m contact openings, wherein these enable a mating contact element of a mating plug connector to access the contact insert or the contact elements located therein. Here, the variables n and m are numbers from the natural number range {1, 2, 3, . . . }. In at least one embodiment, the number m is greater than n. This means that fewer connection openings than contact openings are provided in the contact insert.

In some embodiments, the contact insert has a plurality of contact elements. The contact elements each have a connection region for electrical connection to a conductor of the multi-strand cable and a contact region for electrical contacting of a mating contact element of a mating plug connector or a socket. The connection region of the contact element is arranged here in the connection opening and the contact region of the contact element is arranged in the contact opening. Advantageously, the contact elements may be socket contacts. In this case, the socket side is provided with axially forward-facing lamellae, which form a receiving region for a mating contact element designed as a contact pin.

Advantageously, the connection region of the contact elements may be designed as a crimp connection. This contacting technique has proven itself in the case of such contact inserts.

In some embodiments, the contact insert has a bridge contact. The bridge contact has exactly one connection region for electrical connection to a conductor of the multi-strand cable. In addition, the bridge contact has at least two contact regions for the respective electrical contacting of a mating contact element of a mating plug connector or a socket. This means that the electrical currents of a conductor of the connected cable are transmitted, bridged or divided over at least two contact regions. In particular, this can be the so-called neutral conductor of the cable, which is transmitted to several sub-units of a higher-level device, wherein the other conductors, the so-called phase conductors, are divided over the respective sub-units of the device. In this way, a more effective cabling can be realized.

In some embodiments, the bridge contact may have at least three, or exactly three, contact regions for the respective electrical contacting of a mating contact element of a mating plug connector or a socket. In the above example, this would bridge or divide the neutral conductor over three or at least three contact regions.

In some embodiments, the bridge contact may be formed from, among other things, a metal plate. At least two contact regions are attached to one side of the metal plate. On the other side of the metal plate, exactly one connection region is attached, so that the contact regions and the one connection region are electrically conductively connected to each other. In some embodiments, the contact regions may be riveted to the metal plate.

Advantageously, the connection region of the bridge contact may include a pin contact riveted to the metal plate. A socket contact is plugged onto the pin contact. This design has proven to be particularly simple, reliable and cost-effective.

The socket contact of the bridge contact may be identical here to the remaining socket contacts of the contact insert. By using identical components, the production costs can be reduced further still.

In at least one embodiment, the contact insert has a PE contact element. Grounding is relevant to safety, in particular in an industrial environment, and can be easily implemented using the PE contact element. It is advantageous if the PE contact element is designed identically to the other contact elements of the contact insert. In this case, no other tool is required to connect the PE conductor of the cable to be connected.

The contact insert may be installed in a plug connector housing. As already mentioned above, this can be done directly or indirectly via a holding frame. Advantageously, the plug connector housing may be made of plastic. This makes it possible to realize a lighter design of an industrial plug connector.

### BRIEF DESCRIPTION OF THE SEVERAL VIEWS OF THE DRAWINGS

An embodiment of the disclosure is shown in the drawings and will be explained in more detail below.

FIG. 1 shows a perspective view of a contact insert.

FIG. 2 shows a plan view of the connection side of the contact insert.

FIG. 3 shows a plan view of the contact side of the contact insert.

FIG. 4 shows a perspective view of a partial element of a bridge contact.

FIG. 5 shows a perspective view of the entire bridge contact.

### DETAILED DESCRIPTION

The figures may contain partially simplified, schematic representations. Identical reference signs are sometimes used for similar, but possibly non-identical, elements. Different views of similar elements might be scaled differently.

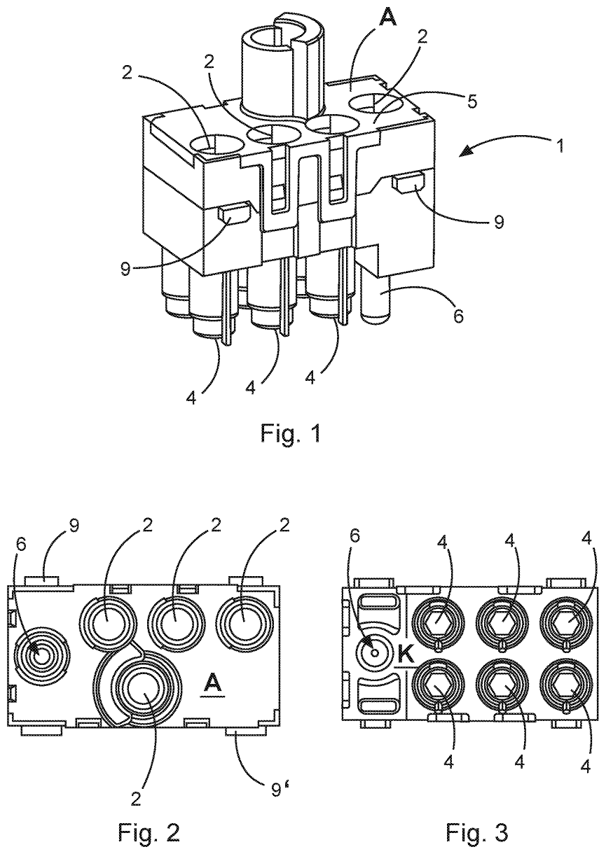

FIG. 1 shows an embodiment of a contact insert 1. The contact insert 1 is shown in perspective, wherein only the connection side A facing upwards is visible to the viewer in this representation. The corresponding opposite side, the contact side K, can be clearly seen in FIG. 3.

An electrical, multi-strand cable (not shown) is connected to the contact insert 1. The cable consists of individual conductors (not shown), each of which is insulatingly sheathed, wherein the conductors are distinguishable by their generally standardized sheath colors. The individual conductors are combined in a multi-strand cable by being enclosed, in turn, in an insulating cable sheath.

The individual conductors of the multi-strand cable are electrically connected to the connection side A of the contact insert 1. For this purpose, the individual conductors are usually first crimped onto a contact element 3 and then inserted into a connection opening 2 of the contact insert. The contact elements 3 are held or fixed in the contact insert 1 by a cover 5 which can be latched to the main body of the contact insert.

The contact side K of the contact insert is intended for electrical connection to a mating plug connector or a socket. The contact side K has contact openings 4 for this purpose. Mating contact elements of a mating plug connector or a socket can access the contact elements 3 of the contact insert via the contact openings K. The principle has long been known and requires no further explanation.

According to the illustrated embodiment, six contact openings 4 are provided on the contact side K to allow access of a mating contact element of a mating plug connector or socket. On the connection side A, only four connection openings 2 are provided for the conductors of the cable to be connected.

Contact elements 3 are used in the contact insert 1, as they can be seen, for example in conjunction with a bridge contact 10, in FIG. 5. The contact elements 3 have a connection region AB, designed as a crimp connection, and a contact region KB, designed as a socket.

The contact insert 1 has a PE contact element 6, which is arranged laterally in a contact chamber of the contact insert 1 specially provided for this purpose.

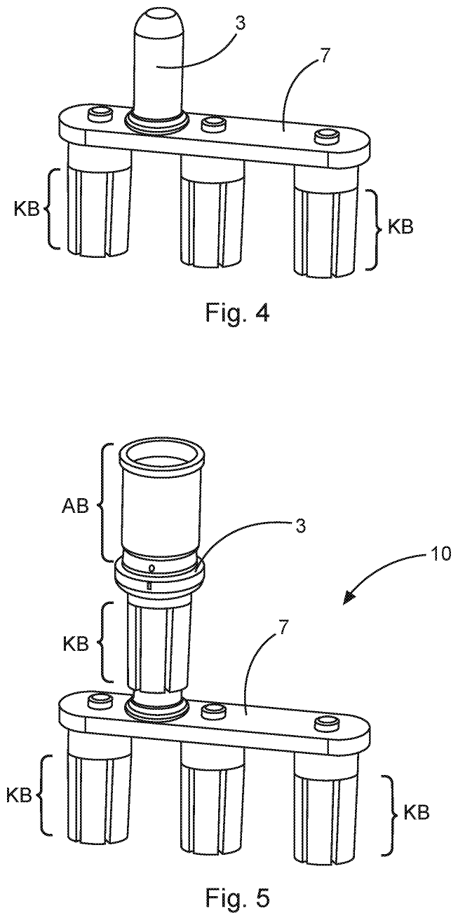

FIG. 5 shows an embodiment of a bridge contact 10. Via the bridge contact 10, an electrical phase or a conductor of the cable can be transferred to three contact regions KB of the contact insert. FIG. 4 shows the part of the bridge contact 10 that is responsible for the actual electrical bridging function.

The bridge contact 10 has a connection region AB for electrical connection to a conductor of the multi-strand cable. The connection region AB is provided by a contact element 3, as is also used for the non-bridged connections of the contact insert 1. In this embodiment, a hollow-cylindrical connection region AB is used for crimping connection of the conductor.

The bridge contact 10 has three contact regions KB for respective electrical contacting of a mating contact element of a mating plug connector or a socket.

The bridge contact 10 consists substantially of an elongate metal plate 7 with rounded end regions. Three contact regions KB are riveted to one side of the metal plate. On the other side of the metal plate 7 there is a pin contact 8, which is also attached to the metal plate 7 by riveting. A contact element 3 is plugged onto the pin contact 8, thus providing a connection region AB for the bridge contact 10.

In order to be able to fix the contact insert 1 in a holding frame (not shown) or directly in a plug connector housing (not shown), the contact insert 1 has holding lugs 9, 9′, which are designed with different widths for polarization reasons.

Even though various aspects or features of the embodiments of the disclosure are each shown in combination in the figures, it is apparent to a person skilled in the art—unless otherwise indicated—that the combinations shown and discussed are not the only possible ones. In particular, corresponding units or feature combinations from different embodiments may be interchanged with each other. Put another way, aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A contact insert for an industrial plug connector, the contact insert comprising:
a connection side for the connection of individual conductors of a multi-strand cable; and
a contact side for electrical connection to a mating plug connector or a socket,
wherein, on the connection side, n connection openings are provided for the conductors of the multi-strand cable,
wherein, on the contact side, m contact openings are provided to allow access to a mating contact element of the mating plug connector or the socket, wherein n and m are natural numbers and m is greater than n.

2. The contact insert according to claim 1, wherein the contact insert comprises at least one contact element having a connection region for electrical connection to a conductor of the multi-strand cable and a contact region for electrical contacting of the mating contact element of the mating plug connector or the socket, wherein the connection region of the contact element is arranged in one or the connection openings on the connection side of the contact insert and the contact region of the contact elements is arranged in one of the contact openings on the contact side of the contact insert.

3. The contact insert according to claim 2, wherein the contact element is designed as a socket contact.

4. The contact insert according to claim 2, wherein the connection region of the contact element is designed as a crimp connection.

5. The contact insert according to claim 1, wherein the contact insert has a bridge contact having exactly one connection region for electrical connection to a conductor of the multi-strand cable and at least two contact regions for respective electrical contacting of a respective mating contact element of the mating plug connector or the socket.

6. The contact insert according to claim 5, wherein the bridge contact has at least three contact regions for respective electrical contacting of the respective mating contact element of the mating plug connector or the socket.

7. The contact insert according to claim 5, wherein the bridge contact is formed from a metal plate wherein at least two contact regions are attached on one side of the metal plate, and wherein exactly one connection region is attached on an other side of the metal plate, so that the contact regions and the one connection region are electrically conductively connected to one another via the metal plate.

8. The contact insert according to claim 7, wherein the contact regions are riveted to the metal plate.

9. The contact insert according to claim 7, wherein the connection region of the bridge contact comprises a pin contact riveted to the metal plate and a socket contact element plugged onto the pin contact.

10. The contact insert according to claim 9, wherein the socket contact element of the bridge contact is identical to the remaining contact elements of the contact insert.

11. The contact insert according to claim 1, wherein the contact insert has a PE contact element.

12. A system, comprising:
a plug connector housing; and
a contact insert according to claim 1.

13. The system according to claim 12, wherein the plug connector housing comprises plastic.

14. A module for modular plug connectors, comprising:
a system according to claim 12, and wherein the module can be inserted into a module holding frame that can be mounted in a modular manner.
